(19) United States
(12) Patent Application Publication
(10) Pub. No.: US 2026/0163793 A1
(43) Pub. Date: Jun. 11, 2026

(54) Method and Apparatus for Signal Transmission

(71) Applicant: Telefonaktiebolaget LM Ericsson (publ), Stockholm (SE)

(72) Inventors: Changlong Guo, Beijing (CN); Fang Gao, Täby (SE); Xudong Lin, Beijing (CN); Nicke Svee, Solna (SE)

(21) Appl. No.: 19/103,879

(22) PCT Filed: Aug. 16, 2022
(86) PCT No.: PCT/CN2022/112720

§ 371 Date: Feb. 14, 2025

(51) Int. Cl. H04L 41/0803; H04L 41/08

(52) U.S. Cl. CPC H04L 41/0803; H04L 41/0886

(57) ABSTRACT

Embodiments of the present disclosure provide methods and apparatuses for signal transmission such as high-speed serial bus signal transmission. A method performed by a retimer adapter comprises obtaining at least one configuration scheme of the retimer adapter. The retimer adapter is able to be connected between a first communication device and a second communication device. The method further comprises configuring the retimer adapter to operate at one of the at least one configuration scheme of the retimer adapter.

### TECHNICAL FIELD

The non-limiting and exemplary embodiments of the present disclosure generally relate to the technical field of communications, and specifically to methods and apparatuses for signal transmission such as high-speed serial bus signal transmission.

### BACKGROUND

This section introduces aspects that may facilitate a better understanding of the disclosure. Accordingly, the statements of this section are to be read in this light and are not to be understood as admissions about what is in the prior art or what is not in the prior art.

Along with high-speed serial bus (Ethernet, Common Public Radio Interface (CPRI) and Fiber Channel etc.) port speed increases from 10 G, 25 G, to 50 G, 100 G and beyond, DAC(Direct Attach Cable) has difficult to reach certain long range (3 m to 5 m) for both impendence discontinuous and inter symbol interference (insertion loss and return loss). Retimer-based solutions are demonstrating its advantages to address such higher speed interconnections demand with the merit on noise cancellation and equalization boosting. Briefly, there may be two types of applications with retimer in market products. The first application case is integrate retimer into host unit high-speed serial bus design (internal links and external links) as shown in FIG. 1a. The second application case is integrate retimer into cable, also call as AEC (Active Electrical Cable) as shown in FIG. 1b.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

For the first application case, it's a good solution for one settled known copper interconnection, for example internal links in case link budget can't meet. But if the interconnection media and distance is flexible, integrate retimer into host unit design can bring obvious negative impacts. Take Ethernet switch as example, its SFP56 (Small Form-factor Pluggable) port supports line rate from 1 Gbps to 50 Gbps and the attached media can be copper cable or optical fiber depends on user deployment scenarios. For low speed and optical fiber cases, generally retimer is not necessary, it means retimer cost and power consumption will be penalty for those use cases.

For the second application case, it's one way for customer to replace DAC in higher-speed network deployment. And there are a lot of articles to address AEC cable benefits compared to DAC. But, existing AEC products drawback is that “not configurable” as a fixed setting for one specific interconnection. It means customer need to know their use case and order ‘customized’ AEC accordingly. Another drawback is, for site devices port speed update use cases, it means need to replace and reroute all existing DAC cables by AEC, which has a significant cost impact as cable routing is an expensive job.

To overcome or mitigate at least one of the above mentioned problems or other problems, an improved solution for signal transmission such as high-speed serial signal transmission over DAC may be desirable.

In a first aspect of the disclosure, there is provided a method performed by a retimer adapter. The method comprises obtaining at least one configuration scheme of the retimer adapter. The method further comprises configuring the retimer adapter to operate at one of the at least one configuration scheme of the retimer adapter. The retimer adapter is able to be connected between a first communication device and a second communication device.

In an embodiment, obtaining at least one configuration scheme of the retimer adapter comprises obtaining the at least one configuration scheme of the retimer adapter from a storage of the retimer adapter.

In an embodiment, obtaining at least one configuration scheme of the retimer adapter comprises obtaining the at least one configuration scheme of the retimer adapter from a communication device.

In an embodiment, the retimer adapter comprises a first interface which is able to be inserted into an interface of the first communication device and the retimer adapter comprises a second interface which is able to be connected to the second communication device via a copper cable.

In an embodiment, the first interface and the second interface comprise at least one of an Ethernet interface, a Common Public Radio Interface (CPRI) interface, or a fiber channel interface.

In an embodiment, the interface comprises at least one of Small Form Pluggable (SFP) port, Quad Small Form-factor Pluggable (QSFP) port, Quad Small Form-factor Pluggable Dual Density (QSFP-DD) port, or Octal Small form-factor Pluggable (OSFP) port.

In an embodiment, the retimer adapter is able to autonomously support at least one pre-defined configuration scheme.

In an embodiment, the retimer adapter is able to be configured with a configuration scheme by a communication device.

In an embodiment, the method further comprises sending information about the retimer adapter to a communication device. The information about the retimer adapter is used by the communication device to determine a configuration scheme of the retimer adapter.

In an embodiment, the method further comprises detecting at least one parameter of a link between a first communication device and a second communication device. The method further comprises searching a configuration scheme matching the at least one parameter from the at least one configuration scheme of the retimer adapter.

In an embodiment, the at least one configuration scheme is stored in a storage of the retimer adapter.

In an embodiment, a configuration scheme of the retimer adapter comprises at least one of a line rate, a modulation technique, a SERializer/DESerializer (SerDes) equalization parameter.

In a second aspect of the disclosure, there is provided a method performed by a communication device. The method comprises receiving information about a retimer adapter from the retimer adapter. The method further comprises determining a configuration scheme of the retimer adapter based on the information about a retimer adapter. The method further comprises sending the configuration scheme of the retimer adapter to the retimer adapter. The retimer adapter is able to be connected between a first communication device and a second communication device.

In an embodiment, the retimer adapter comprises a first interface which is able to be inserted into an interface of the first communication device and the retimer adapter comprises a second interface which is able to be connected to the second communication device via a copper cable.

In an embodiment, the first interface and the second interface comprise at least one of an Ethernet interface, a Common Public Radio Interface (CPRI) interface, or a fiber channel interface.

In an embodiment, the interface comprises at least one of Small Form Pluggable (SFP) port, Quad Small Form-factor Pluggable (QSFP) port, Quad Small Form-factor Pluggable Dual Density (QSFP-DD) port, or Octal Small form-factor Pluggable (OSFP) port.

In an embodiment, the retimer adapter is able to work autonomously to support at least one pre-defined configuration scheme.

In an embodiment, a configuration scheme of the retimer adapter comprises at least one of a line rate, a modulation technique, a SERializer/DESerializer (SerDes) equalization parameter.

In a third aspect of the disclosure, there is provided a retimer adapter. The retimer adapter comprises a retimer circuit configured to receive a signal from a communication device and regenerate the signal and send the signal to another communication device. The retimer adapter further comprises an obtaining circuit configured to obtain at least one configuration scheme of the retimer adapter. The retimer adapter further comprises a configuration circuit configured to configure the retimer adapter to operate at one of the at least one configuration scheme of the retimer adapter. The retimer adapter is able to be connected between a first communication device and a second communication device.

In an embodiment, the obtaining circuit is further configured to obtain the at least one configuration scheme of the retimer adapter from a storage of the retimer adapter and/or obtain the at least one configuration scheme of the retimer adapter from a communication device.

In an embodiment, the retimer adapter further comprises a first interface which is able to be inserted into an interface of the first communication device and the retimer adapter further comprises a second interface which is able to be connected to the second communication device via a copper cable.

In an embodiment, the first interface and the second interface comprise at least one of an Ethernet interface, a Common Public Radio Interface (CPRI) interface, or a fiber channel interface.

In an embodiment, the interface comprises at least one of Small Form Pluggable (SFP) port, Quad Small Form-factor Pluggable (QSFP) port, Quad Small Form-factor Pluggable Dual Density (QSFP-DD) port, or Octal Small form-factor Pluggable (OSFP) port.

In an embodiment, the retimer adapter is able to autonomously support at least one pre-defined configuration scheme.

In an embodiment, the retimer adapter is able to be configured with a configuration scheme by a communication device.

In an embodiment, the retimer adapter further comprises a sending circuit configured to send information about the retimer adapter to a communication device. The information about the retimer adapter is used by the communication device to determine a configuration scheme of the retimer adapter.

In an embodiment, the retimer adapter further comprises a detecting circuit configured to detect at least one parameter of a link between a first communication device and a second communication device. The retimer adapter further comprises a searching circuit configured to search a configuration scheme matching the at least one parameter from the at least one configuration scheme of the retimer adapter.

In an embodiment, the at least one configuration scheme is stored in a storage of the retimer adapter.

In an embodiment, a configuration scheme of the retimer adapter comprises at least one of a line rate, a modulation technique, a SERializer/DESerializer (SerDes) equalization parameter.

In a fourth aspect of the disclosure, there is provided a communication device. The communication device comprises a processor and a memory coupled to the processor. Said memory contains instructions executable by said processor. Said communication device is operative to receive information about a retimer adapter from the retimer adapter. Said communication device is further operative to determine a configuration scheme of the retimer adapter based on the information about a retimer adapter. Said communication device is further operative to send the configuration scheme of the retimer adapter to the retimer adapter. The retimer adapter is able to be connected between a first communication device and a second communication device.

In a fifth aspect of the disclosure, there is provided a communication device. The communication device comprises a receiving module configured to receive information about a retimer adapter from the retimer adapter. The retimer adapter is able to be connected between a first communication device and a second communication device. The communication device further comprises a determining module configured to determine a configuration scheme of the retimer adapter based on the information about a retimer adapter. The communication device further comprises a sending module configured to send the configuration scheme of the retimer adapter to the retimer adapter.

In a sixth aspect of the disclosure, there is provided a computer program product, comprising instructions which, when executed by a retimer adapter, cause the retimer adapter to carry out the method according to any of the first and second aspects.

In a seventh aspect of the disclosure, there is provided a computer-readable storage medium storing instructions which when executed by a retimer adapter, cause the retimer adapter to carry out the method according to any of the first and second aspects.

Embodiments herein afford many advantages, of which a non-exhaustive list of examples follows. Some embodiments herein provide a retimer adapter which may work autonomously, i.e., plug and play. In some embodiments herein, the proposed solution can remove retimer from the communication device, which can save unit cost. In some embodiments herein, depending on customer use case, the proposed solution may provide flexibility when and how to use the retimer adapter. In some embodiments herein, the retimer adapter consumes half power compared to AEC which builts retimer on cable both ends. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a shows an example of integrating retimer into host unit;

FIG. 1b shows an example of integrating retimer into cable;

FIG. 1c is a diagram illustrating an exemplary communication system into which an embodiment of the disclosure is applicable;

FIG. 2a is a diagram illustrating an exemplary communication system into which an embodiment of the disclosure is applicable;

FIG. 2b an example of work mode of the RT-based adapter according to an embodiment of the present disclosure;

FIG. 2c shows an example of autonomous work mode of the RT-based adapter according to an embodiment of the present disclosure;

FIG. 2d shows an example of host-configured work mode of the RT-based adapter according to an embodiment of the present disclosure;

FIG. 3 is a block diagram showing a communication system with a retimer adapter according to an embodiment of the present disclosure;

FIG. 4 is a diagram illustrating a formfactor of a retimer adapter according to an embodiment of the present disclosure;

FIG. 5 is a diagram illustrating how the adapter co-work with a communication device according to an embodiment of the present disclosure;

FIG. 6 is a diagram illustrating a DAC according to an embodiment of the present disclosure;

FIG. 7 shows a flowchart of a method according to an embodiment of the present disclosure;

FIG. 8 shows a flowchart of a method according to another embodiment of the present disclosure;

FIG. 9 shows a flowchart of a method according to another embodiment of the present disclosure;

FIG. 10 shows a flowchart of a method according to another embodiment of the present disclosure;

FIG. 11 is a block diagram showing a retimer adapter according to an embodiment of the present disclosure;

FIG. 12 is a block diagram showing an apparatus suitable for practicing some embodiments of the disclosure; and FIG. 13 is a block diagram showing a communication device according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced (LTE-A), wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “communication device” or “network device” refers to any suitable network function (NF) which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network. For example, the data center network may comprises computer, server, host, switch, router, etc.

Virtualizing means creating virtual versions of apparatuses or devices which may include virtualizing hardware platforms, storage devices and networking resources. As used herein, virtualization can be applied to a provider edge node and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments hosted by one or more of hardware nodes. Further, in embodiments in which the virtual node is not a radio access node or does not require radio connectivity (e.g., a core network node), then the provider edge node or PE may be entirely virtualized.

The functions may be implemented by one or more applications (which may alternatively be called software instances, virtual appliances, network functions, virtual nodes, virtual network functions, etc.) operative to implement some of the features, functions, and/or benefits of some of the embodiments disclosed herein. Applications are run in virtualization environment which provides hardware comprising processing circuitry and memory. Memory contains instructions executable by processing circuitry whereby application is operative to provide one or more of the features, benefits, and/or functions disclosed herein.

Virtualization environment, comprises general-purpose or special-purpose network hardware devices comprising a set of one or more processors or processing circuitry, which may be commercial off-the-shelf (COTS) processors, dedicated Application Specific Integrated Circuits (ASICs), or any other type of processing circuitry including digital or analog hardware components or special purpose processors. Each hardware device may comprise memory which may be non-persistent memory for temporarily storing instructions or software executed by processing circuitry. Each hardware device may comprise one or more network interface controllers (NICs), also known as network interface cards, which include physical network interface. Each hardware device may also include non-transitory, persistent, machine-readable storage media-having stored therein software and/or instructions executable by processing circuitry. Software may include any type of software including software for instantiating one or more virtualization layers (also referred to as hypervisors), software to execute virtual machines as well as software allowing it to execute functions, features and/or benefits described in relation with some embodiments described herein.

Virtual machines, comprise virtual processing, virtual memory, virtual networking or interface and virtual storage, and may be run by a corresponding virtualization layer or hypervisor. Different embodiments of the instance of virtual appliance may be implemented on one or more of virtual machines, and the implementations may be made in different ways.

During operation, processing circuitry executes software to instantiate the hypervisor or virtualization layer, which may sometimes be referred to as a virtual machine monitor (VMM). Virtualization layer may present a virtual operating platform that appears like networking hardware to virtual machine.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

It is noted that some embodiments of the present disclosure are mainly described in relation to Ethernet device and interface being used as non-limiting examples for certain exemplary network device and network interface. As such, the description of exemplary embodiments given herein specifically refers to terminology which is directly related thereto. Such terminology is only used in the context of the presented non-limiting examples and embodiments, and does naturally not limit the present disclosure in any way. Rather, any other network device and network interface may equally be utilized as long as exemplary embodiments described herein are applicable.

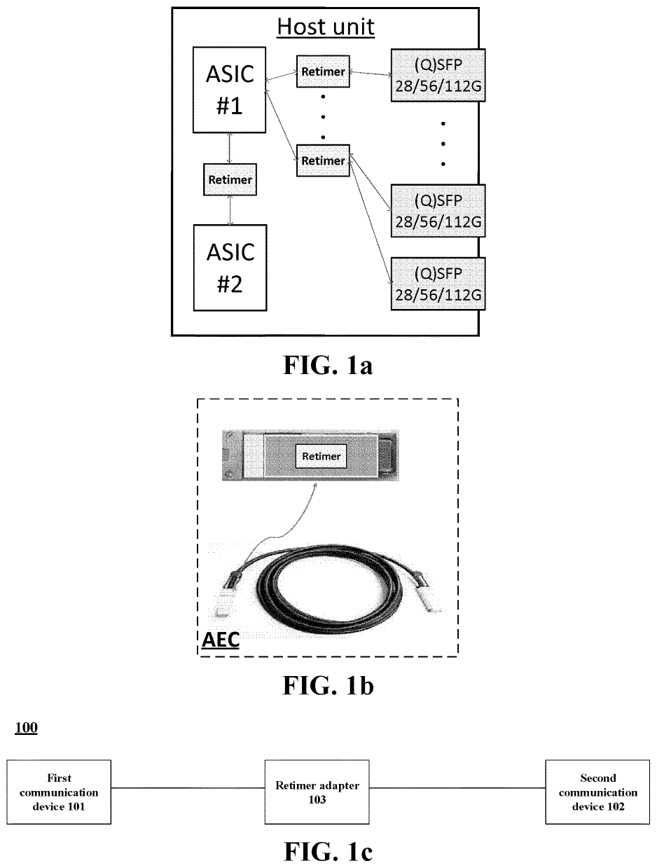

FIG. 1c is a diagram illustrating an exemplary communication system into which an embodiment of the disclosure is applicable. As shown, the communication system 100 may comprise a first communication device 101, a second communication device 102, and a retimer adapter 103.

The first communication device 101 and the second communication device 102 may be any suitable communication devices which are able to support at least data transmission function. For example, the first communication device 101 and the second communication device 102 may be a device having Ethernet (ETH) port or CPRI interface or fiber channel interface.

The two communication devices may communicate with each other by using any suitable communication protocol or interface protocol or bus protocol, etc. For example, the communication protocol may be Ethernet protocol.

The two communication devices may be devices of the same type. Alternatively, The two communication devices may be devices of different types. For example, the two communication devices may be switches or routers.

The retimer adapter 103 may be connected between the first communication device 101 and the second communication device 102 in various ways.

In an embodiment, the retimer adapter 103 comprises a first interface which is able to be inserted into an interface of the first communication device 101. The retimer adapter 103 comprises a second interface which is able to be connected to the second communication device 102 via a copper cable.

A first signal from the first communication device 101 is output to the second communication device 102 after passing through the retimer adaper 103. A second signal from the second communication device 102 is output to the first communication device 101 after passing through the retimer adaper 103.

The communication system 100 shown in FIG. 1c includes only one retimer adaper 103 connected between the first communication device 101 and the second communication device 102. In other embodiments, the communication system 100 may include two or more retimer adapers 103 connected between the first communication device 101 and the second communication device 102.

The retimer adapter 103 can detect at least one parameter (such as line rate, etc) of a link between a first communication device 101 and a second communication device 102. The retimer adapter 103 can search a configuration scheme matching to the at least one parameter from the at least one configuration scheme of the retimer adapter. The retimer adapter 103 can configure a retimer circuit to operate at the matched configuration scheme.

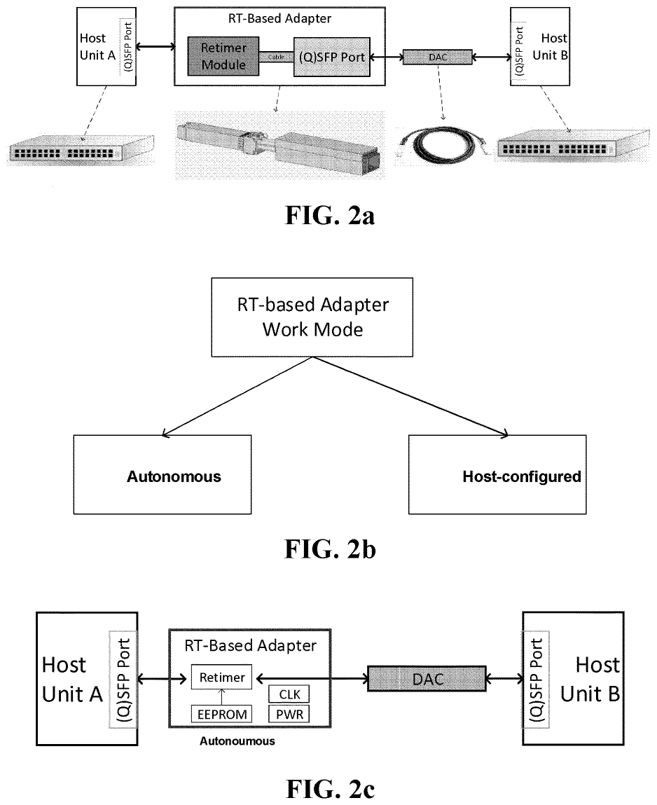

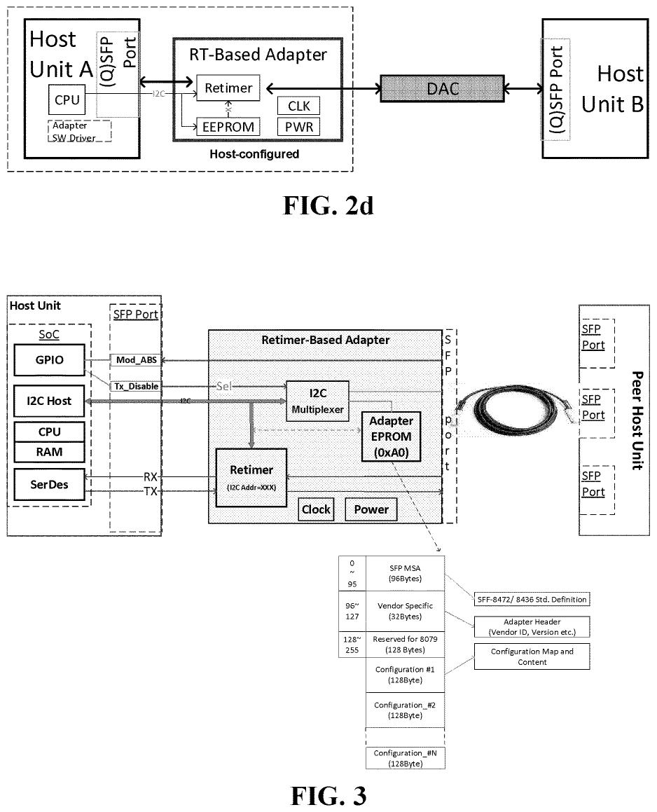

FIG. 2a is a diagram illustrating an exemplary communication system into which an embodiment of the disclosure is applicable. As shown, the communication system 200 may comprise a host unit A, a host unit B and a retimer (RT) based adapter. The RT-based adapter may comprise a retimer module and (Q)SFP port. The retimer module and the (Q)SFP port may be connected by a cable. The RT-based adapter is connected between the host unit A and the host unit B. FIG. 2a also shows an example of formfactor of the RT-based adapter, host unit A, host unit B and DAC.

The host unit A and the host unit B have a (Q)SFP port. A first port of the RT-based adapter can be inserted into the (Q)SFP port of the host unit A. A second port of the adapt unit can be connected to the host unit B via a DAC cable.

The RT-based adapter can detects at least one parameter (such as line rate, etc.) of a link between the host unit A and the host unit B. The RT-based adapter can search a configuration scheme matching to the at least one parameter from the at least one configuration scheme of the retimer adapter. The RT-based adapter can configure the retimer module (or circuit) to operate at the a matched configuration scheme.

It is note that the RT-based adapter may comprise any other suitable module or circuit. In addition, the RT-based adapter may have any other suitable interface.

The RT-based adapter can be designed to work with two modes: autonomous mode and host-configured mode as shown in FIG. 2b.

FIG. 2c shows an example of autonomous work mode of the RT-based adapter according to an embodiment of the present disclosure.

In this mode, an adapter developer or user can pre-define at least one configuration scheme of the retimer adapter and store them in non-volatile memory (EEPROM (Electrically Erasable Programmable read only memory) as example), and the RT-based adapter can fetch them through I2C bus during adapter power-up.

A configuration scheme of the retimer adapter may comprise any suitable parameter and the present disclosure has no limit on it. For example, a configuration scheme may comprise line rates, modulation technique (e.g., NRZ(Non-Return-to-Zero) or PAM(Pulse Amplitude Modulation)), optimized SerDes equalization parameters that retimer can support.

Depends on retimer type (protocol-aware or protocol-unaware), retimer engagement is different during the link set-up procedure between host unit A and host unit B. Whatever retimer type, adapter autonomous mode uses EEPROM fetched configuration parameters to run, and doesn't need host unit interaction for operation. But in another hand, host unit can't OAM (operate and manage) the RT-based adapter for real time troubleshooting or fault handling, which is the limitation of this mode.

An example of host unit A capability may be as following:
Ethernet: 1/10/25/50/100 GbE etc. per lane.
CPRI: 2.5/4.9/9.8/10.1/24.3 Gbps etc. per lane
Fiber Channel (FC): 14.025/28.05/28.9/57.8 Gbaud etc. per lane An example of host unit B capability may be as following:
Ethernet: 1/10/25/50/100 GbE etc. per lane.
CPRI: 2.5/4.9/9.8/10.1/24.3 Gbps etc.
Fiber Channel (FC): 14.025/28.05/28.9/57.8 Gbaud etc. per lane.
The RT-based adapter may comprise a clock (CLK) module and a power (PWR) module.

FIG. 2d shows an example of host-configured work mode of the RT-based adapter according to an embodiment of the present disclosure.

In this mode, Host unit A can initialize adapter, configure at least one parameter such as retimer lane line rate, modulation technique (e.g., NRZ or PAM), SerDes equalization parameters though (Q)SFP I2C management bus. Adapter EEPROM can be used to store adapter information in its memory space. The RT-based adapter can map SFF (Small Form Factor) management interface specification (e.g., SFF-8472 or SFF-8436) to provide adapter information such as adapter vendor name, device type, retimer IC vendor ID (identifier) and other vendor specific information etc. to host unit A. When RT-based adapter works in this mode, there is dependency (compared with the autonomous mode) on the Host unit A. Host unit A can recognize adapter (fully support adapter functionality) and enable it.

The host unit A may comprise a CPU and a retimer adapter software (SW) driver.

The RT-based adapter may comprise a clock (CLK) module and a power (PWR) module.

FIG. 3 is a block diagram showing a communication system with a retimer adapter according to an embodiment of the present disclosure.

As shown, the communication system may comprise a host unit, a peer host unit and a retimer-based adapter. The retimer-based adapter is connected between the host unit and the peer host unit.

The host unit may comprise a System on a Chip (SoC) and SFP port. The SoC may comprise GPIO (General-purpose input/output) circuit, I2C (Inter-Integrated Circuit) host, CPU (central processing unit), RAM(Random Access Memory), SerDes (SERializer/DESerializer), etc. The peer host unit may have similar modules.

Note that only some exemplary modules of the host unit are shown in FIG. 3. In other embodiment, the host unit and/or the peer host unit may have more or less modules. In addition, the host unit and/or the peer host unit may have any other suitable modules.

The retimer-based adapter may comprise an I2C multiplexer, a retimer circuit, an adaper EEPROM(Electrically Erasable Programmable Read-Only-Memory), a clock circuit, a power circuit, etc. In other embodiment, the retimer-based adapter may have more or less modules. In addition, the retimer-based adapter may have any other suitable modules.

The adapter EEPROM may store at least one configuration scheme of the retimer adapter (e.g., line rates, modulation technique and SerDes equalization parameter)which is supported by the retimer.

For example, the adapter EEPROM may store SFP MSA (multi-source agreement) information (such as SFF-8472/8436 standard definition), vendor specific information (such as Adapter Header Vendor ID, Version etc.), configuration information (such as Configuration Map and Content).

The retimer circuit may be configured to operate at one of the at least one configuration scheme of the retimer adapter.

The retimer-based adapter may work with two modes: Autonomous and Host-configured mode.

Note that only some exemplary modules of the retimer-based adapter are shown in FIG. 3. In other embodiment, the retimer-based adapter may have more or less modules. In addition, the retimer-based adapter may have any other suitable modules.

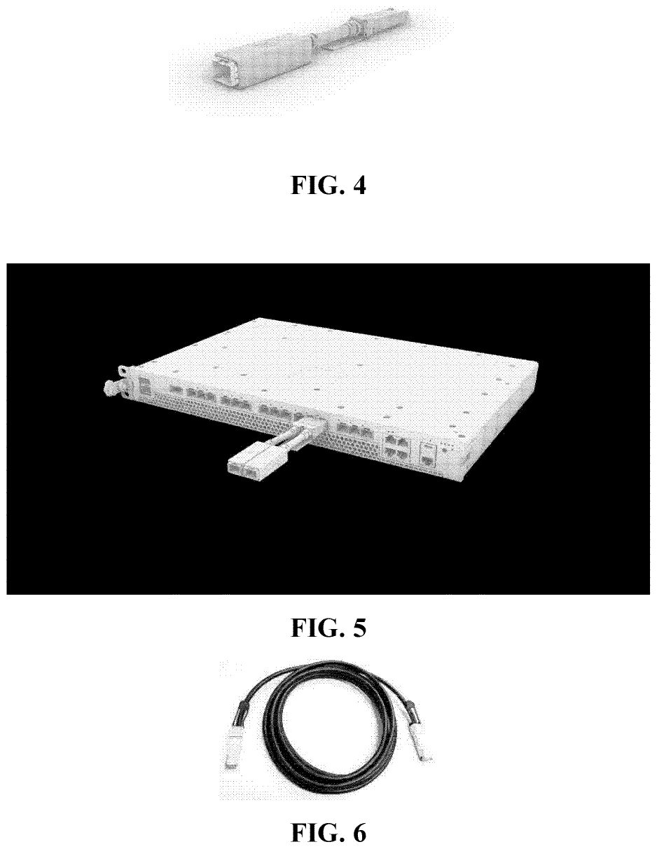

FIG. 4 is a diagram illustrating a formfactor of a retimer adapter according to an embodiment of the present disclosure.

FIG. 5 is a diagram illustrating how the adapter co-work with a communication device according to an embodiment of the present disclosure.

FIG. 6 is a diagram illustrating a DAC according to an embodiment of the present disclosure.

As shown in FIGS. 4-6, the retimer adapter comprises a first interface which is able to be inserted into an interface of the first communication device. The retimer adapter further comprises a second interface which is able to be connected to the second communication device via a copper cable.

As above two application cases compensations, a retimer-based adapter is proposed. It proposes a new product building practice and formfactor to utilize Retimer IC to support higher Ethernet speed via copper cable. The retimer-based adapter can work autonomously with host unit A and unit B without host involvement, that's to say plug and play.

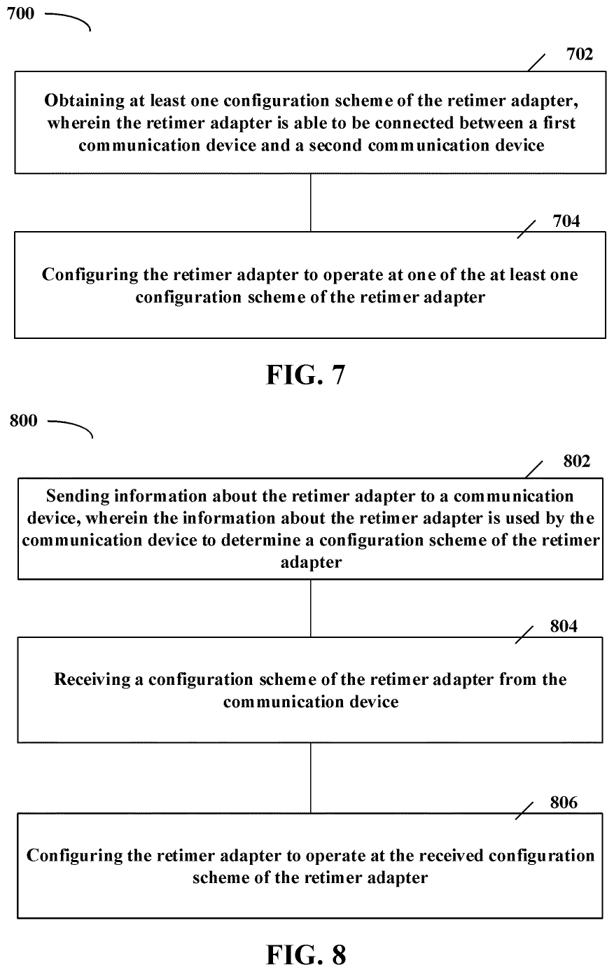

FIG. 7 shows a flowchart of a method according to an embodiment of the present disclosure, which may be performed by an apparatus implemented in or as or communicatively coupled to a retimer adapter or any other entity having similar functionality. As such, the retimer adapter may provide means or modules or circuit for accomplishing various parts of the method 700 as well as means or modules for accomplishing other processes in conjunction with other components. For some parts which have been described in the above embodiments, detailed description thereof is omitted here for brevity.

At block 702, the retimer adapter may obtain at least one configuration scheme of the retimer adapter. The retimer adapter is able to be connected between a first communication device and a second communication device.

The first communication device and the second communication device may be any suitable communication devices.

In an embodiment, the retimer adapter comprises a first interface which is able to be inserted into an interface of the first communication device and the retimer adapter comprises a second interface which is able to be connected to the second communication device via a copper cable

The first interface and the second interface may be any suitable interface. In an embodiment, the first interface and the second interface comprise at least one of an Ethernet interface, a Common Public Radio Interface (CPRI) interface, or a fiber channel interface.

The Ethernet interface may be any suitable Ethernet port type. In an embodiment, the interface comprises at least one of Small Form Pluggable (SFP) port, e.g., (SFP10/28/56/112), Quad Small Form-factor Pluggable (QSFP) port, e.g., QSFP28/56/112, Quad Small Form-factor Pluggable Dual Density (QSFP-DD) port, or Octal Small form-factor Pluggable (OSFP) port.

In an embodiment, the retimer adapter is able to work autonomously to support at least one pre-defined configuration scheme.

In an embodiment, the retimer adapter is able to be configured with a configuration scheme by a communication device.

The line rate may be any suitable line rate and he present disclosure has no limit on it. In an embodiment, the line rates may be the line rates where the retimer is suitable to be used or supported by the retimer.

A configuration scheme of the retimer adapter may comprise any suitable configuration parameter. In an embodiment, a configuration scheme of the retimer adapter comprises at least one of a line rate, a modulation technique, a SERializer/DESerializer (SerDes) equalization parameter.

In an embodiment, the at least one configuration scheme is stored in a storage (such as non-volatile storage) of the retimer adapter.

In an embodiment, the retimer adapter may detect a line rate and/or a transmission mode of a link between the first communication device and the second communication device.

In an embodiment, the retimer adapter may be configured to operate at a specific configuration scheme.

The retimer adapter may obtain the at least one configuration scheme of the retimer adapter in various ways.

In an embodiment, the retimer adapter may obtain the at least one configuration scheme of the retimer adapter from a storage of the retimer adapter. For example, an adapter developer or user can pre-define at least one configuration scheme of the retimer adapter and store them in non-volatile memory (EEPROM as example), and the RT-based adapter can fetch them through I2C bus during adapter power-up. For example, when the retimer adapter works with autonomous mode, the retimer adapter can obtain the at least one configuration scheme of the retimer adapter from a storage of the retimer adapter.

In an embodiment, the retimer adapter may obtain the at least one configuration scheme of the retimer adapter from a communication device. For example, when the retimer adapter works with host-configured mode, the retimer adapter may obtain the at least one configuration scheme of the retimer adapter from a communication device.

At block 704, the retimer adapter may configure the retimer adapter to operate at one of the at least one configuration scheme of the retimer adapter.

FIG. 8 shows a flowchart of a method according to another embodiment of the present disclosure, which may be performed by an apparatus implemented in or as or communicatively coupled to a retimer adapter or any other entity having similar functionality. As such, the retimer adapter may provide means or modules or circuit for accomplishing various parts of the method 800 as well as means or modules for accomplishing other processes in conjunction with other components. For some parts which have been described in the above embodiments, detailed description thereof is omitted here for brevity.

At block 802, the retimer adapter may send information about the retimer adapter to a communication device. The information about the retimer adapter is used by the communication device to determine a configuration scheme of the retimer adapter.

The information about the retimer adapter may comprise any suitable information such as adapter vendor name, device type, retimer vendor ID and other vendor specific information etc.

In an embodiment, the information about the retimer adapter may comprise information about at least one configuration scheme supported by the retimer adapter.

At block 804, the retimer adapter may receive a configuration scheme of the retimer adapter from the communication device.

At block 806, the retimer adapter may configure the retimer adapter to operate at the received configuration scheme of the retimer adapter.

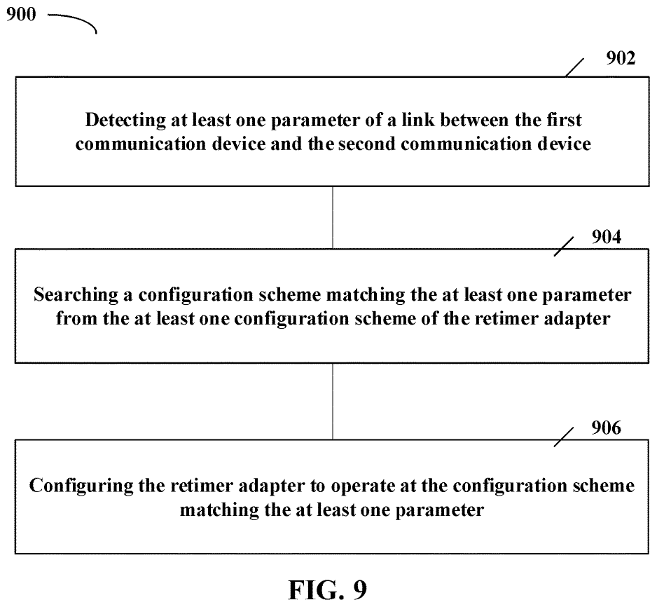

FIG. 9 shows a flowchart of a method according to another embodiment of the present disclosure, which may be performed by an apparatus implemented in or as or communicatively coupled to a retimer adapter or any other entity having similar functionality. As such, the retimer adapter may provide means or modules or circuit for accomplishing various parts of the method 900 as well as means or modules for accomplishing other processes in conjunction with other components. For some parts which have been described in the above embodiments, detailed description thereof is omitted here for brevity.

At block 902, the retimer adapter may detect at least one parameter of a link between the first communication device and the second communication device.

At block 904, the retimer adapter may search a configuration scheme matching the at least one parameter from the at least one configuration scheme of the retimer adapter.

At block 906, the retimer adapter may configure the retimer adapter to operate at the configuration scheme matching the at least one parameter.

In an embodiment, the retimer adapter may configure the retimer circuit to receive signal at the determined line rate and/or the determined transmission mode from a first communication device and regenerate the signal at the determined line rate and/or the determined transmission mode and send the signal at the determined line rate and/or the determined transmission mode to the second communication device.

In an embodiment, the retimer adapter may configure the retimer circuit to receive a signal at the determined line rate and/or the determined transmission mode from a second communication device and regenerate the signal at the determined line rate and/or the determined transmission mode and send the signal at the determined line rate and/or the determined transmission mode to the first communication device.

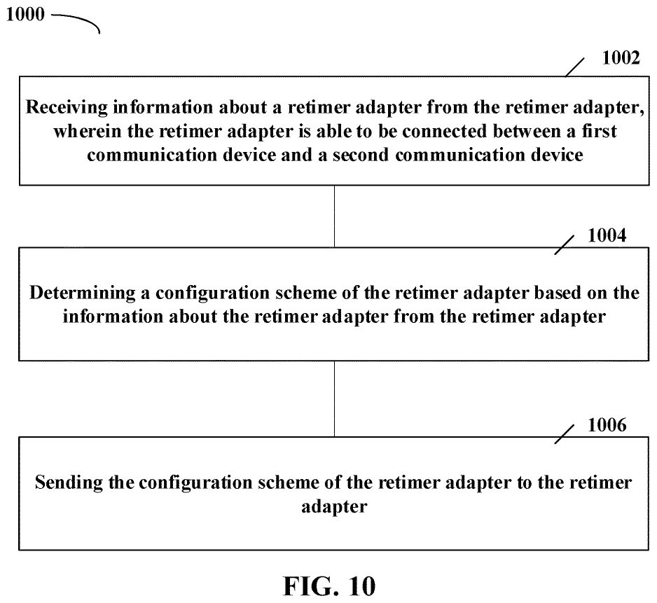

FIG. 10 shows a flowchart of a method according to another embodiment of the present disclosure, which may be performed by an apparatus implemented in or as or communicatively coupled to a communication device or any other entity having similar functionality. As such, the communication device may provide means or modules or circuit for accomplishing various parts of the method 1000 as well as means or modules for accomplishing other processes in conjunction with other components. For some parts which have been described in the above embodiments, detailed description thereof is omitted here for brevity.

At block 1002, the communication device may receive information about a retimer adapter from the retimer adapter. The retimer adapter is able to be connected between a first communication device and a second communication device.

At block 1004, the communication device may determine a configuration scheme of the retimer adapter based on the information about a retimer adapter.

The information about the retimer adapter may comprise any suitable information such as adapter vendor name, device type, retimer vendor ID and other vendor specific information etc.

In an embodiment, the information about the retimer adapter may comprise at least one configuration scheme supported by the retimer adapter.

For example, the communication device may determine at least one configuration scheme supported by the retimer adapter based on the information about the retimer adapter. And then the communication device may determining a configuration scheme from the at least one configuration scheme supported by the retimer adapter for example based on the capability of communication device and its peer communication device and/or service requirements, etc.

At block 1006, the communication device may send the configuration scheme of the retimer adapter to the retimer adapter.

In an embodiment, the retimer adapter comprises a first interface which is able to be inserted into an interface of the first communication device and the retimer adapter comprises a second interface which is able to be connected to the second communication device via a copper cable.

In an embodiment, the first interface and the second interface comprise at least one of an Ethernet interface, a Common Public Radio Interface (CPRI) interface, or a fiber channel interface.

In an embodiment, the interface comprises at least one of Small Form Pluggable (SFP) port, Quad Small Form-factor Pluggable (QSFP) port, Quad Small Form-factor Pluggable Dual Density (QSFP-DD) port, or Octal Small form-factor Pluggable (OSFP) port.

In an embodiment, the retimer adapter is able to work autonomously to support at least one pre-defined configuration scheme.

In an embodiment, a configuration scheme of the retimer adapter comprises at least one of a line rate, a modulation technique, a SERializer/DESerializer (SerDes) equalization parameter.

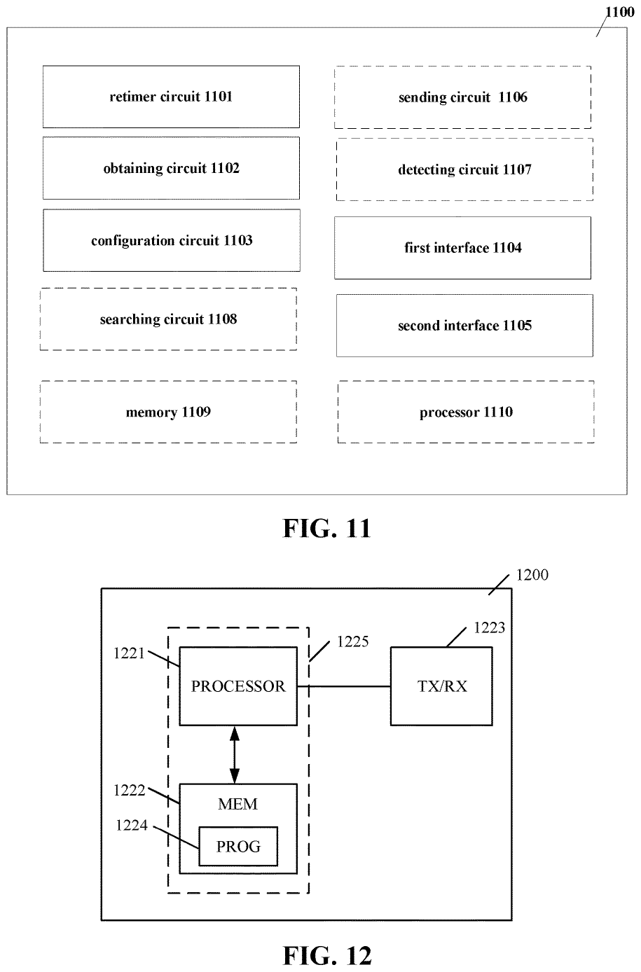

FIG. 11 is a block diagram showing a retimer adapter according to an embodiment of the present disclosure.

The retimer adapter 1100 comprises a retimer circuit 1101 configured to receive a signal from a communication device and regenerate the signal and send the signal to another communication device.

The retimer adapter 1100 further comprises an obtaining circuit 1102 configured to obtain at least one configuration scheme of the retimer adapter. The retimer adapter is connected between a first communication device and a second communication device.

The retimer adapter 1100 further comprises a configuration circuit 1103 configured to configure the retimer adapter to operate at one of the at least one configuration scheme of the retimer adapter.

In an embodiment, the obtaining circuit 1102 is further configured to obtain the at least one configuration scheme of the retimer adapter from a storage of the retimer adapter; and/or obtain the at least one configuration scheme of the retimer adapter from a communication device.

In an embodiment, the retimer adapter further comprises a first interface 1104 which is able to be inserted into an interface of the first communication device and the retimer adapter further comprises a second interface 1105 which is able to be connected to the second communication device via a copper cable.

In an embodiment, the retimer adapter further comprises a sending circuit 1106 configured to send information about the retimer adapter to a communication device. The information about the retimer adapter is used by the communication device to determine a configuration scheme of the retimer adapter.

In an embodiment, the retimer adapter further comprises a detecting circuit 1107 configured to detect at least one parameter of a link between a first communication device and a second communication device.

In an embodiment, the retimer adapter further comprises a searching circuit 1108 configured to search a configuration scheme matching the at least one parameter from the at least one configuration scheme of the retimer adapter.

In an embodiment, the retimer adapter 1100 further comprises a memory 1109 configured to store the at least one configuration scheme.

The memory 1109 may be of any type suitable to the local technical environment and may be implemented using any suitable data storage technology, such as semiconductor based memory devices, magnetic memory devices and systems, optical memory devices and systems, fixed memories and removable memories, as non-limiting examples.

In an embodiment, optionally, the retimer adapter 1100 further comprises a processor 1110.

The processor 1110 may be of any type suitable to the local technical environment, and may include one or more of general purpose computers, special purpose computers, microprocessors, digital signal processors DSPs and processors based on multicore processor architecture, as non-limiting examples.

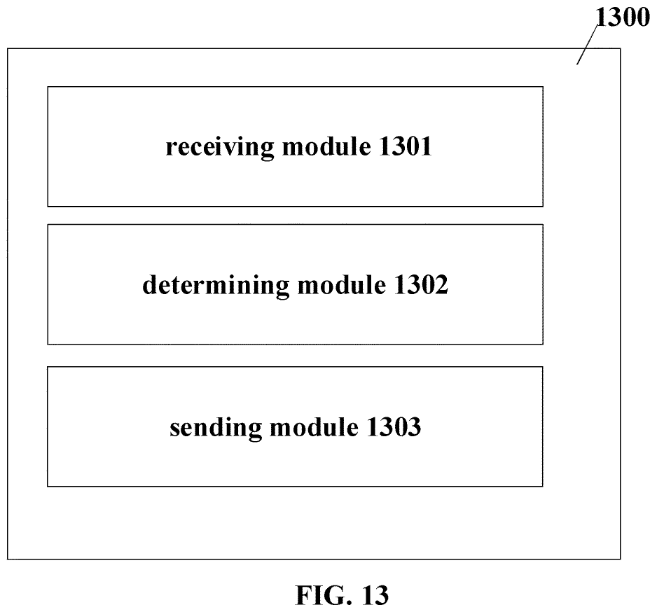

FIG. 12 is a block diagram showing an apparatus suitable for practicing some embodiments of the disclosure. For example, the communication device described above may be implemented as or through the apparatus 1200.

The apparatus 1200 comprises at least one processor 1221, such as a digital processor (DP), and at least one memory (MEM) 1222 coupled to the processor 1221. The apparatus 1200 may further comprise a transmitter TX and receiver RX 1223 coupled to the processor 1221. The MEM 1222 stores a program (PROG) 1224. The PROG 1224 may include instructions that, when executed on the associated processor 1221, enable the apparatus 1200 to operate in accordance with the embodiments of the present disclosure. A combination of the at least one processor 1221 and the at least one MEM 1222 may form processing means 1225 adapted to implement various embodiments of the present disclosure.

Various embodiments of the present disclosure may be implemented by computer program executable by one or more of the processor 1221, software, firmware, hardware or in a combination thereof.

The MEM 1222 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1221 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the communication device, the memory 1222 contains instructions executable by the processor 1221, whereby the communication device operates according to any of the methods related to the communication device as described above.

FIG. 13 is a block diagram showing a communication device according to an embodiment of the disclosure. As shown, the communication device 1300 comprises a receiving module 1301 configured to receive information about a retimer adapter from the retimer adapter. The retimer adapter is able to be connected between a first communication device and a second communication device. The communication device 1300 further comprises a determining module 1302 configured to determine a configuration scheme of the retimer adapter based on the information about a retimer adapter. The communication device 1300 further comprises a sending module 1303 configured to send the configuration scheme of the retimer adapter to the retimer adapter.

Embodiments herein afford many advantages, of which a non-exhaustive list of examples follows. Some embodiments herein provide a retimer adapter which may work autonomously, i.e., plug and play. In some embodiments herein, the proposed solution can remove retimer from the communication device, which can save unit cost. In some embodiments herein, depending on customer use case, the proposed solution may provide flexibility when and how to use the retimer adapter. In some embodiments herein, the retimer adapter consumes half power compared to AEC which builts retimer on cable both ends. The embodiments herein are not limited to the features and advantages mentioned above. A person skilled in the art will recognize additional features and advantages upon reading the following detailed description.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-32. (canceled)

33. A method performed by a retimer adapter, comprising:
obtaining at least one configuration scheme of the retimer adapter; and
configuring the retimer adapter to operate at one of the at least one configuration scheme of the retimer adapter,
wherein the retimer adapter is able to be connected between a first communication device and a second communication device.

34. The method according to claim 33, wherein obtaining at least one configuration scheme of the retimer adapter comprises:
obtaining the at least one configuration scheme of the retimer adapter from a storage of the retimer adapter; and/or
obtaining the at least one configuration scheme of the retimer adapter from a communication device.

35. The method according to claim 33, wherein the retimer adapter comprises a first interface which is able to be inserted into an interface of the first communication device and the retimer adapter comprises a second interface which is able to be connected to the second communication device via a copper cable.

36. The method according to claim 35, wherein the first interface and the second interface comprise at least one of:
an Ethernet interface,
a Common Public Radio Interface (CPRI) interface, or
a fiber channel interface.

37. The method according to claim 36, wherein an interface comprises at least one of:
a Small Form Pluggable (SFP) port,
a Quad Small Form-factor Pluggable (QSFP) port,
a Quad Small Form-factor Pluggable Dual Density (QSFP-DD) port, or
a Octal Small form-factor Pluggable (OSFP) port.

38. The method according to claim 33, wherein the retimer adapter is configured to work autonomously to support at least one pre-defined configuration scheme.

39. The method according to claim 33, wherein the retimer adapter is configurable with a configuration scheme by a communication device.

40. The method according to claim 33, further comprising sending information about the retimer adapter to a communication device, wherein the information about the retimer adapter is usable to determine a configuration scheme of the retimer adapter.

41. The method according to claim 33, further comprising:
detecting at least one parameter of a link between the first communication device and the second communication device; and
searching a configuration scheme matching the at least one parameter from the at least one configuration scheme of the retimer adapter.

42. The method according to claim 33, wherein the at least one configuration scheme is stored in a storage of the retimer adapter.

43. The method according to claim 33, wherein a configuration scheme of the retimer adapter comprises at least one of:
a line rate,
a modulation technique, or
a SERializer/DESerializer (SerDes) equalization parameter.

44. A method performed by a communication device, comprising:
receiving, from a retimer adapter that is connectable between a first communication device and a second communication device, information about the retimer adapter;
determining a configuration scheme of the retimer adapter based on the information about the retimer adapter; and
sending the configuration scheme of the retimer adapter to the retimer adapter.

45. The method according to claim 44, wherein the retimer adapter comprises a first interface which is able to be inserted into an interface of the first communication device and the retimer adapter comprises a second interface which is able to be connected to the second communication device via a copper cable.

46. The method according to claim 45, wherein the first interface and the second interface comprise at least one of:
an Ethernet interface,
a Common Public Radio Interface (CPRI) interface, or
a fiber channel interface.

47. The method according to claim 46, wherein an interface comprises at least one of:
Small Form Pluggable (SFP) port,
Quad Small Form-factor Pluggable (QSFP) port,
Quad Small Form-factor Pluggable Dual Density (QSFP-DD) port, or
Octal Small form-factor Pluggable (OSFP) port.

48. The method according to claim 44, wherein the retimer adapter is configured to work autonomously to support at least one pre-defined configuration scheme.

49. The method according to claim 44, wherein a configuration scheme of the retimer adapter comprises at least one of:
a line rate,
a modulation technique, or
a SERializer/DESerializer (SerDes) equalization parameter.

50. A retimer adapter, comprising:
a retimer circuit configured to receive a signal from a communication device, regenerate the signal, and send the signal to another communication device;
an obtaining circuit configured to obtain at least one configuration scheme of the retimer adapter; and
a configuration circuit configured to configure the retimer adapter to operate at one of the at least one configuration scheme of the retimer adapter,
wherein the retimer adapter is able to be connected between a first communication device and a second communication device.

51. The retimer adapter according to claim 50, wherein the obtaining circuit is further configured to:
obtain the at least one configuration scheme of the retimer adapter from a storage of the retimer adapter; and/or
obtain the at least one configuration scheme of the retimer adapter from a communication device.

52. The retimer adapter according to claim 50, wherein the retimer adapter further comprises a first interface which is able to be inserted into an interface of the first communication device and the retimer adapter further comprises a second interface which is able to be connected to the second communication device via a copper cable.
